(19) United States
(12) Patent Application Publication
(10) Pub. No.: US 2003/0225824 A1
(43) Pub. Date: Dec. 4, 2003

(54) System and method for transferring image data to a server

(76) Inventors: Vincent Wu, Irvine, CA (US); David J. Park, Torrance, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/156,331

(22) Filed: May 28, 2002

(51) Int. Cl. G06F 15/16

(52) U.S. Cl. 709/203

(57) ABSTRACT

This invention is directed to a system and method for transferring image data to a file server. More particularly, this invention is directed to a system and method for transferring image data from a document reading device, such as a scanning device, to a file transfer protocol (FTP) server via FTP.

### BACKGROUND OF THE INVENTION

This invention is directed to a system and method for transferring image data to a server. More particularly, this invention is directed to a system and method for transferring image data from a document reading device, such as a scanning device, to a file transfer protocol (FTP) server via FTP.

Typically, when a user uses a scanner, copier, or other document reading device, the generated image data is saved to shared network drives to be processed further. These shared network drives are easily accessed from a Windows environment. However, non-Windows users often have problems accessing the data in the shared network drives and have to go through a cumbersome process to move the data to a local workstation after the data is generated. For example, if a user wants to send the image data to a remote FTP server by FTP, the user needs to move the data to a device that has the FTP capability and send the data to the FTP server. Further, a user may need to install an application or spend additional time configuring his workstation or device in order to access the data.

There is a need for a system and method for easily transferring image data to a server and which enables easy access to the image data by Window users and non-Windows users.

### SUMMARY OF THE INVENTION

In accordance with the present invention, there is provided a system and method for easily transferring image data to a server.

Further, in accordance with the present invention, there is provided a system and method which enables easy access to image data by Windows users and non-Windows users.

Still further, in accordance with the present invention, there is provided a system for transferring image data from a document reading device to a server. The system comprises means adapted for receiving image data from an associated document reading device. The system also comprises means adapted for selecting an associated data transfer signal, the data transfer signal including data representative of at least one selected data transfer format and a data transfer target. The system further comprises means adapted for transmitting the image data via a data transfer system from an associated document reading device to an associated file server in accordance with the data transfer selection signal.

Still further, in accordance with the present invention, there is provided a method for transferring image data from a document reading device to a server. The method comprises receiving image data from an associated document reading device. The method further comprises selecting an associated data transfer signal, the data transfer signal including data representative of at least one selected data transfer format and a data transfer target. The method also comprises transmitting the image data via a data transfer system from an associated document reading device to an associated server in accordance with the data transfer selection signal.

Advantages of the system and method of the present invention, include, but are not limited to, the ability to easily transfer image data between a document reading device and a file server and the ability for Windows users and non-Windows users to easily access the image data.

These and other advantages, aspects, and features will be understood by one of ordinary skill in the art upon reading and understanding the specification.

### BRIEF DESCRIPTION OF THE DRAWINGS

FIG. 1 is a block diagram illustrating the preferred embodiment of the system according to the present invention.

FIGS. 2a and 2b show a sample summary template for the desired settings for the document reading device and the desired data transfer signal.

FIGS. 3a, 3b, and 3c show sample templates for selecting the desired settings for the document reading device.

FIG. 4 shows a sample template for selecting the desired data transfer signal for transmitting the generated image data to the file server.

FIG. 5 is a sample screen that shows the status of the transfer of the image data.

### DETAILED DESCRIPTION OF THE PREFERRED EMBODIMENT

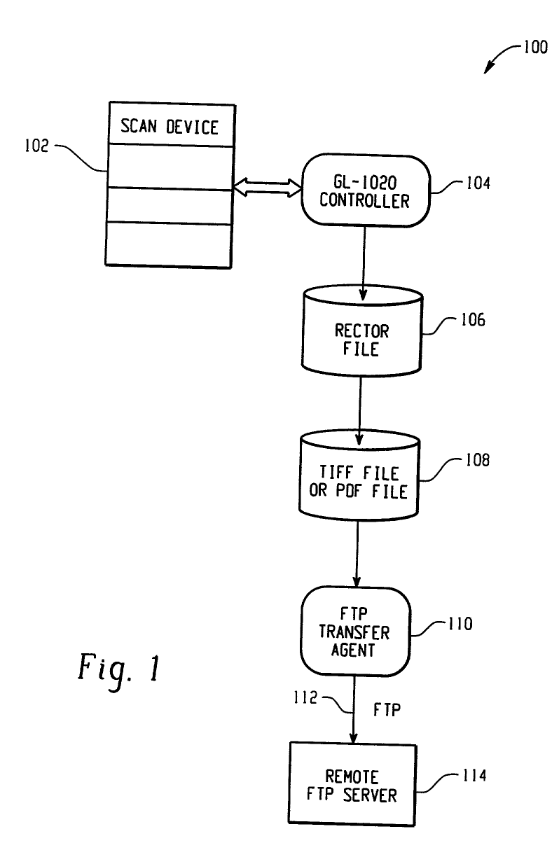

The present invention is directed to a system and method for transferring image data from a document reading device to a server. FIG. 1 shows a block diagram preferred embodiment of the system according to the present invention generally designated as 100. The system comprises a document reading device 102, such as a scanner or copier, for generating image data. The document reading device is any suitable document reading device known in the art. Preferably, the document reading device is a scanning device, a copying device, and an optical character recognition device. More preferably, the document reading device is a scanning device. Suitable commercially available document reading devices include, but are not limited to, the Toshiba e-Studio Series Controller. The document reading device further comprises a controller 104 which controls the functions of the document reading device and includes storage means for storing the image data.

In operation, the user inputs the document or other data into the document reading device to generate the image data and selects the desired settings for generating the image data. The image data is stored as a rector file 106 on the controller or any other suitable memory device. The image data is then converted by the controller to an appropriate format, such as TIFF or PDF, as shown by 108. A Transfer Agent 110 is used to access the image data on the controller. An data transfer session is initiated on the communication link 112 to the remote file server 114 whereupon the image data is transferred to the remote file server via a data transfer system. The communication link is comprised of one or more segments of wired or wireless communications. Suitable communications link include, but are not limited to, FTPLIB-3.1. In a preferred embodiment, the file server is an FTP server and the data transfer system is FTP. Preferably, the data transfer is completed on an system operating under Linux or Unix.

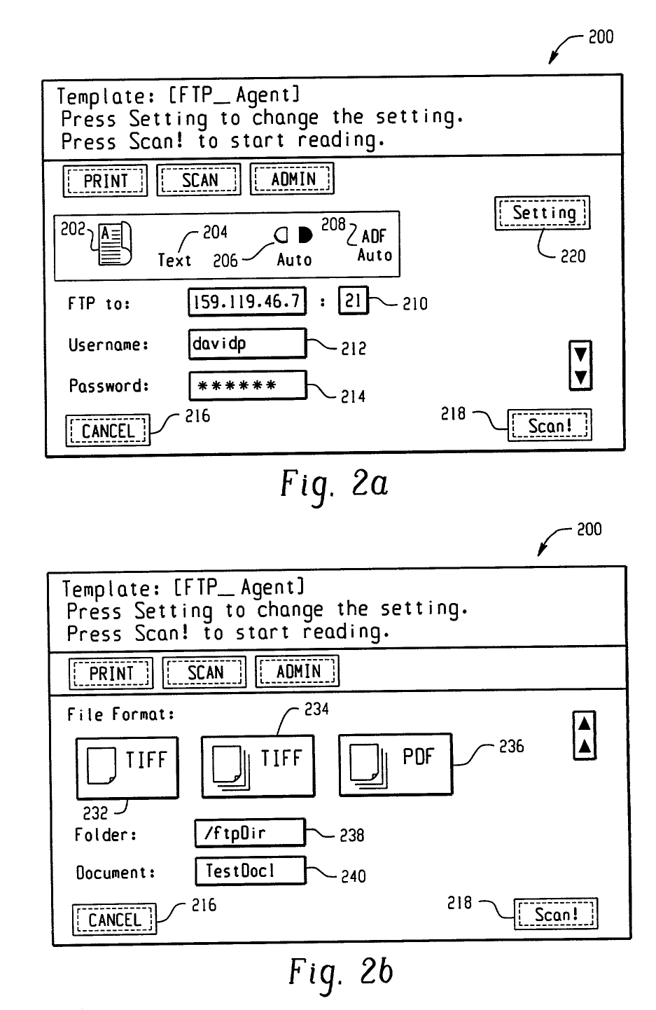

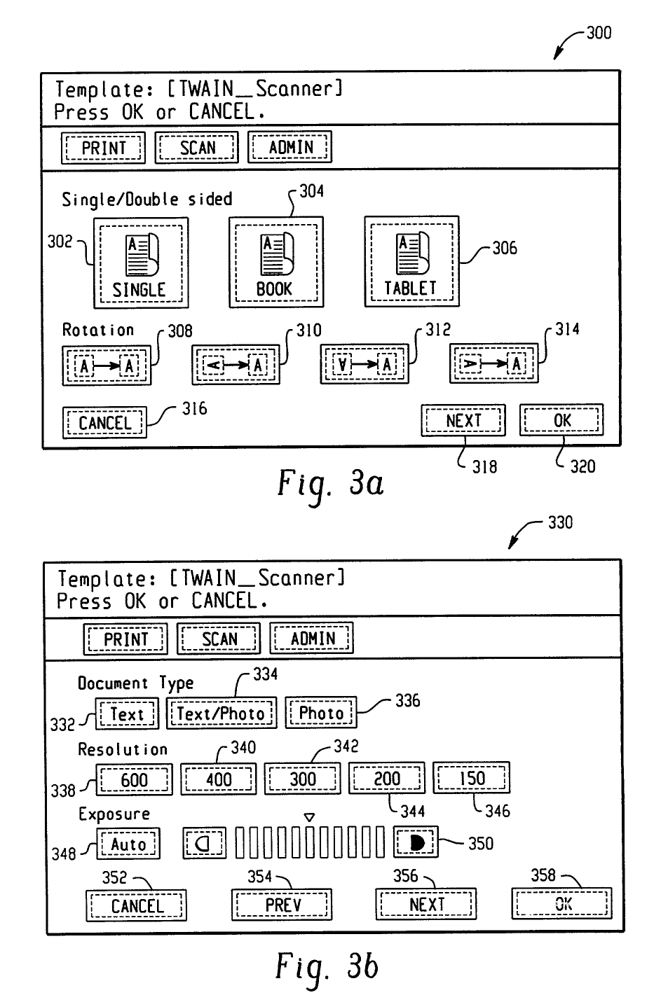

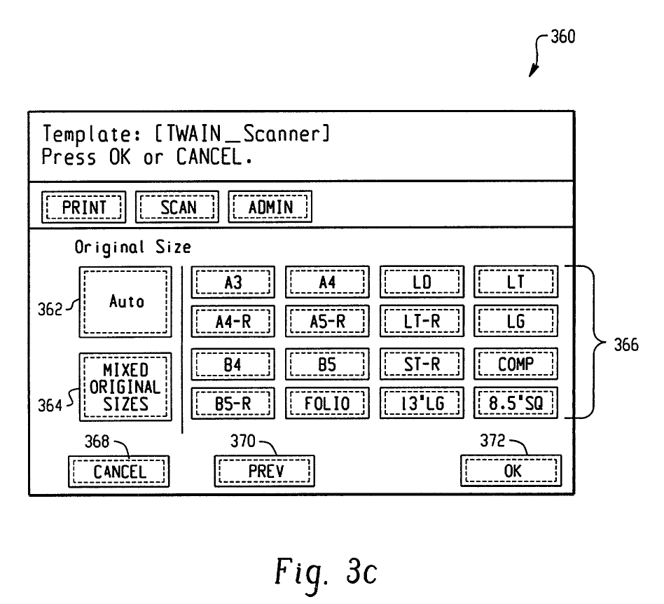

The controller 104 includes means adapted for selecting the desired settings for generating the image data and means adapted for selecting a desired data transfer signal for transferring the generated image data to the server. FIGS. 2a and 2b show a preferred sample summary template for the desired settings for the document image device and the desired transfer signal. FIG. 2a shows the top half of summary screen 200. The screen shows the document scanning method 202, the document type 204, the exposure 206, and the paper size 208 chosen. The screen also shows the IP address and port of the server to which the image data is to be transferred 210, the usemame 212, and the password 214 of the user. The user selects the Cancel button 216 to cancel the settings or the Scan button 218 to initiate the process. The user can also select the Settings button 220 to change the scanning parameters as shown in FIGS. 3a, 3b, and 3c.

FIG. 2b shows the bottom half of summary screen 200. The screen shows the selected the desired file format as selected from single page TIFF 222, multi-page TIFF 224, and multi-page PDF 226. The screen also shows the selected the folder in which the image data is to be store 228 and the document name for the image data 230.

Preferred sample screen displays for selecting the desired settings for generating the image data is shown in FIGS. 3a, 3b, and 3c. FIG. 3a shows scanning parameter setting screen 1 shown as 300. The user selects if the document is to be scanned using a single page method 302, book method 304, or tablet method 306. The user next specifies the rotation from the four choices shown as 308, 310, 312, and 314. The user can cancel the settings by selecting the Cancel button 316. The user can go to scanning parameter screen 2 by selecting the Next button 318. The user can also proceed to selecting the appropriate agent and associated data transfer signal by selecting the OK button 320.

FIG. 3b shows scanning parameter screen 2 as 330. The user first selects the document type as either text 332, text/photo 334, and photo 336. The user then selects the resolution for the image data from 600 dots per inch (dpi) 338, 400 dpi 340, 300 dpi 342, 200 dpi 344, and 150 dpi 346. The user then selects the exposure mode from Auto 348 or manual 350. The user can cancel the settings by selecting the Cancel button 352. The user can go back to scanning parameter screen 1 by selecting the Prev button 354. The user can go to scanning parameter screen 3 by selecting the Next button 356. The user can also proceed to selecting the appropriate agent and associated data transfer signal by selecting the OK button 358.

FIG. 3c shows scanning parameter screen 3 as 360. The user can select Auto 362 for auto paper size detection mode. The user can also select Mixed Original Sizes 364 for the mixed original sizes mode. The user can also select the original paper size from the choices shown in region 366. The user can cancel the settings by selecting the Cancel button 368. The user can go back to scanning parameter screen 2 by selecting the Prev button 370. The user can also proceed to selecting the appropriate agent and associated data transfer signal by selecting the OK button 372.

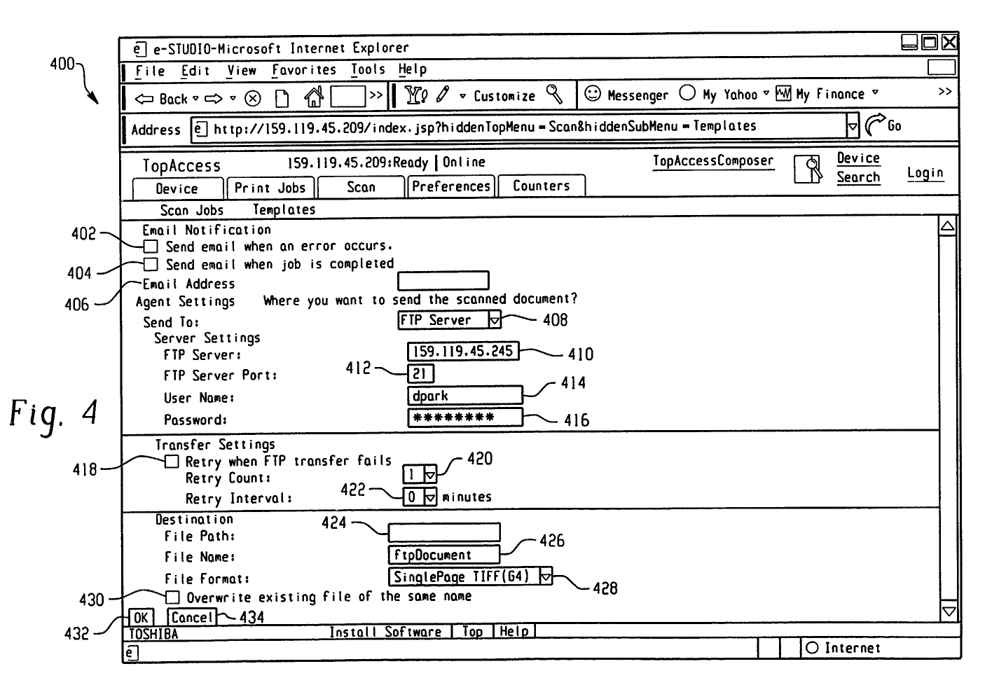

A preferred sample screen display 400 for selecting the desired agent and associated data transfer signal is shown in FIG. 4. The user first selects whether an e-mail should be sent to the user when an error occurs 402 and/or whether an e-mail should be sent to the user when the job is completed 404. The user then enters the e-mail address to which to send the notifications 406. The user then selects the desired agent to which the image data should be sent as shown at 408. The user then specifies the server settings by selecting the file server 410 and the file server port 412 to which the image data is to be transferred. The user then inputs his usemame 414 and password on the file server account 416. The user then selects the transfer settings by selecting the option to retry when the transfer fails 418. If the user selects to retry should the transfer fail, the user then inputs the retry count 420 and the retry interval 422. The user then provides the destination parameters by specifying the file path 424 and the file name 426 for the image data. The user next selects the particular file format in which the image data is to be transferred which is shown as 428. The image data format is preferably selected from PDF, single page TIFF, and multi-page TIFF. The user can also select whether to overwrite an existing file of the same name by checking the box shown as 430. The user can then select the OK button 432 to save the settings or the Cancel button 434 to cancel the settings entered.

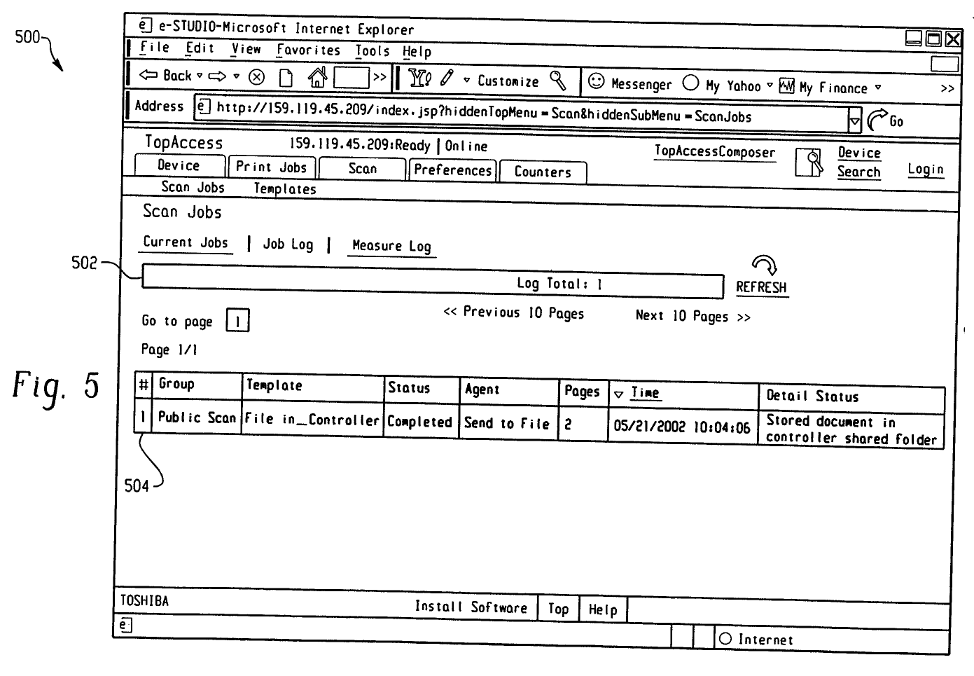

Upon selecting the OK button, the controller 104 begins the process of transferring the image data to the file server. In one embodiment, the status of the job is provided by a sample status screen as shown in FIG. 5 as 500. The job log is shown as 502 and the status of a particular job is shown as 504. Electronic mail notifications as to the status and any errors are also sent to the user as described above.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for transferring image data from a document reading device to a server comprising:
means adapted for receiving image data from an associated document reading device;
means adapted for selecting an associated data transfer signal, the data transfer signal including data representative of at least one selected data transfer format and a data transfer target; and
means adapted for transmitting the image data via a data transfer system from an associated document reading device to an associated server in accordance with the data transfer selection signal.

2. The system according to claim 1 comprising means adapted for transmitting image data from the document reading device to a document reading device controller in accordance with the data transfer signal and means adapted for transmitting the image data from the document reading device controller to the server in accordance with the data transfer signal.

3. The system according to claim 2 wherein the document reading device controller converts the image data to a selected format prior to transmitting the image data to the server.

4. The system according to claim 3 wherein the document reading device controller first converts the image data to rector format and then converts the image data to the selected format in accordance with the data transfer signal.

5. The system according to claim 1 further comprising means adapted for selecting parameters for generating the image data.

6. The system according to claim 1 wherein the server is a file transfer protocol server.

7. The system according to claim 1 wherein the data transfer format is selected from the group consisting of TIFF and PDF.

8. The system according to claim 1 wherein the data transfer system is file transfer protocol.

9. The system according to claim 1 wherein the document reading device is selected from the group consisting of an image scanning device and an optical character recognition device.

10. The system according to claim 9 wherein the data transfer is completed on an system operating under Linux or Unix.

11. A method for transferring image data from a document reading device to a server comprising:
receiving image data from an associated document reading device;
selecting an associated data transfer signal, the data transfer signal including data representative of at least one selected data transfer format and a data transfer target; and
transmitting the image data via a data transfer system from an associated document reading device to an associated server in accordance with the data transfer selection signal.

12. The method according to claim 11 further comprising transmitting image data from the document reading device to a document reading device controller in accordance with the data transfer signal and transmitting the image data from the document reading device controller to the server in accordance with the data transfer signal.

13. The method according to claim 12 wherein the document reading device controller converts the image data to a selected format prior to transmitting the image data to the server.

14. The method according to claim 13 wherein the document reading device controller first converts the image data to rector format and then converts the image data to the selected format in accordance with the data transfer signal.

15. The method according to claim 11 further comprising selecting parameters for generating the image data.

16. The method according to claim 11 wherein the server is a file transfer protocol server.

17. The method according to claim 11 wherein the data transfer format is selected from the group consisting of TIFF and PDF.

18. The method according to claim 11 wherein the data transfer system is file transfer protocol.

19. The method according to claim 11 wherein the document reading device is selected from the group consisting of an image scanning device and an optical character recognition device.

20. The method according to claim 19 wherein the data transfer is completed on an system operating under Linux or Unix.

21. A computer readable medium of instructions for transferring image data from a document reading device to a server comprising:
means adapted for receiving image data from an associated document reading device;
means adapted for selecting an associated data transfer signal, the data transfer signal including data representative of at least one selected data transfer format and a data transfer target; and
means adapted for transmitting the image data via a data transfer system from an associated document reading device to an associated server in accordance with the data transfer selection signal.

22. A computer-implemented method for transferring image data from a document reading device to a server comprising:
receiving image data from an associated document reading device;
selecting an associated data transfer signal, the data transfer signal including data representative of at least one selected data transfer format and a data transfer target; and
transmitting the image data via a data transfer system from an associated document reading device to an associated server in accordance with the data transfer selection signal.
